(19) United States
(12) Patent Application Publication
(10) Pub. No.: US 2014/0178662 A1
(43) Pub. Date: Jun. 26, 2014

(54) Multilayer Polyarylene Sulfide Composite

(71) Applicant: TICONA LLC, Florence, KY (US)

(72) Inventors: Rong Luo, Florence, KY (US); Peggy Pike, Elsmere, KY (US); James DiVita, Union, KY (US); James Howard, Dry Ridge, KY (US); Scott Large, Bethel, OH (US); Xinyu Zhao, Cincinnati, OH (US)

(73) Assignee: TICONA LLC, Florence, KY (US)

(21) Appl. No.: 13/800,273

(22) Filed: Mar. 13, 2013

Related U.S. Application Data
(60) Provisional application No. 61/739,889, filed on Dec. 20, 2012.

(51) Int. Cl. B32B 5/04

(52) U.S. Cl. CPC B32B 5/04
USPC 428/220; 264/257

(57) ABSTRACT

A multilayer composite is described as well as methods for forming the multilayer composite and products that incorporate the multilayer composite. The multilayer composite includes a continuous fiber composite first layer and a second layer that is formed from the melt directly on the continuous fiber composite. The continuous fiber composite includes a plurality of unidirectionally aligned carbon fibers embedded within a polymer composition that includes a first polyarylene sulfide. The second layer includes a second polymer composition that can be the same as or different from the first polymer composition. Products can include electronic devices such as computers, cellular telephones, e-readers, etc. as well as panels, such as interior panels in vehicles.

### CROSS REFERENCE TO RELATED APPLICATION

The present application claims filing benefit of U.S. Provisional Patent Application Ser. No. 61/739,889 having a filing date of Dec. 20, 2012, which is incorporated herein by reference in its entirety.

### BACKGROUND OF THE INVENTION

Electronic devices such as tablet PCs, ultrabooks, e-readers and smart phones are extremely popular with the public. Over time, such consumer electronics have become increasingly thin and light in design, which is both popular with and beneficial to consumers, but presents design problems for manufacturers. For instance metal alloys such as magnesium aluminum alloys are often used to form housings and covers of such products, but metals are expensive and require a painting step during a formation process. Polymeric materials have been examined for use in forming electronic devices, but the mechanical property requirements for large, thin products such as these are very stringent, and with thinner product designs, existing polymeric materials fail to meet manufacturers' requirements.

Attempts have been made to use polymers to form structures that are both thin and strong by use of continuous fiber/polymer composites. For example, continuous fiber composites in the form of composite sheets, tapes or ribbons have been combined in multiple layers to form a multilayer plaque that can then be molded to the desired shape. Unfortunately, adherence between individual layers of these composites tends to be less than desirable, and delamination is a common problem. In addition, continuous fiber/polymer composites are relatively expensive to produce, and formation of multilayer composites can be cost prohibitive.

Another significant problem with continuous fiber composites is that they often rely upon thermoset resins (e.g., vinyl esters) to help achieve the desired strength properties. Thermoset resins are difficult to use during manufacturing and do not possess good bonding characteristics for forming composites with other materials. In response, attempts have been made to form continuous fiber composites with thermoplastic resins. Unfortunately, the thermoplastic resins utilized often cannot withstand high temperature processing and present additional problems as discussed above.

In an attempt to alleviate such problems, polyarylene sulfides have been examined as a thermoplastic matrix for use in forming a variety of products including continuous fiber/polymer composites and products with a small cross sectional dimension. Polyarylene sulfides are high-performance polymers that may withstand high thermal, chemical, and mechanical stresses and are beneficially utilized in a wide variety of applications. Unfortunately, the problems of delamination between layers of a composite as well as costs associated with multilayer continuous fiber/polymer composites continues to present issues in utilization of these materials in many applications.

A need currently exists for polymeric materials that can be used to form products having a small cross-sectional dimension that are also quite strong and robust, such as housings and covers for electronic devices, interior panels in transportation applications, and so forth. Useful materials will be capable of achieving the strength, durability, and temperature performance demanded by desired applications while exhibiting good processibility characteristics during formation.

### SUMMARY OF THE INVENTION

In accordance with one embodiment, a multilayer composite is disclosed that has a cross sectional dimension of less than about 10 millimeters. The multilayer composite includes a continuous fiber composite first layer and a second layer directly molded on the first layer. The first layer contains a plurality of oriented continuous fibers embedded in a first polymer composition that includes a first polyarylene sulfide. The second layer is formed of a second polymer composition that includes a second polyarylene sulfide.

In accordance with another embodiment, a method for forming a multilayer composite is disclosed. The method includes melt processing a first polymer composition that includes a first polyarylene sulfide and applying the first polymer composition in the melt onto a continuous fiber composite. The continuous fiber composite contains a plurality of oriented continuous fibers embedded in a second polymer composition that includes a second polyarylene sulfide. The first polymer composition can be applied to the continuous fiber composite according to any suitable molding methodology such as, without limitation, injection molding, hot stamping, thermoforming, and so forth.

Also disclosed are products incorporating the multilayer composite. Products can include, for example, housings or portions of housings for electronic devices such as e-book readers, phones, laptop computers, notebook computers, ultrabooks, tablets, and so forth. Products can also include panels for use in transportation applications such as interior automobile or airplane panels, seat panels, and so forth.

Other features and aspects of the present invention are set forth in greater detail below.

### BRIEF DESCRIPTION OF THE DRAWINGS

A full and enabling disclosure of the present disclosure, including the best mode thereof to one skilled in the art, is set forth more particularly in the remainder of the specification, including reference to the accompanying figures, in which:

FIG. 1 is a perspective view of one embodiment of a multilayer composite as described herein.

FIG. 2 is a perspective view of one embodiment of a continuous fiber composite as described herein.

FIG. 3 is a cross-sectional view of a composite tape including a continuous fiber composite formed with continuous fiber rovings.

FIG. 4 is a schematic illustration of one embodiment of an impregnation system for use in forming a continuous fiber composite.

FIG. 5 is a schematic illustration of one embodiment of an injection molding system that may be employed in forming a multilayer composite.

FIG. 6 is a schematic illustration of an electronic device that may incorporate the multilayer composite.

FIG. 7 is a perspective view of the electronic device of FIG. 6, shown in closed configuration.

FIG. 8 is a schematic illustration of another electronic device that may incorporate the multilayer composite including a front view (FIG. 8A) and a side view (FIG. 8B).

FIG. 9 is a schematic illustration of an airplane fuselage as may incorporate the multilayer composite as described herein.

FIG. 10 illustrates the results of a multiaxial impact test on multilayer composites as described herein including the maximum load (FIG. 10A) and total energy (FIG. 10B).

FIG. 11 illustrates the flexural properties of multilayer composites as described herein including flexural modulus (FIG. 11A), flexural stress (FIG. 11B), and flexural strain (FIG. 11C).

Repeat use of reference characters in the present specification and drawings is intended to represent the same or analogous features or elements of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention.

Generally speaking, the present disclosure is directed to multilayer polyarylene sulfide-based composites for use in a variety of applications. The present disclosure is also directed to methods of forming the multilayer composites and products that can be formed from the multilayer composites. Beneficially, the multilayer composites can exhibit excellent strength characteristics including impact resistance, flexural modulus, flexural strength, and flexural strain. As such, the multilayer composites can be useful in forming a wide variety of products, and particularly products that define a small cross sectional dimension such as electronic devices. The multilayer composites can also be useful in forming other types of products that require high strength and light weight and have a small cross sectional dimension such as seats, structural panels, table tops, etc. in transportation applications, e.g., aircraft, buses, automobiles, etc.

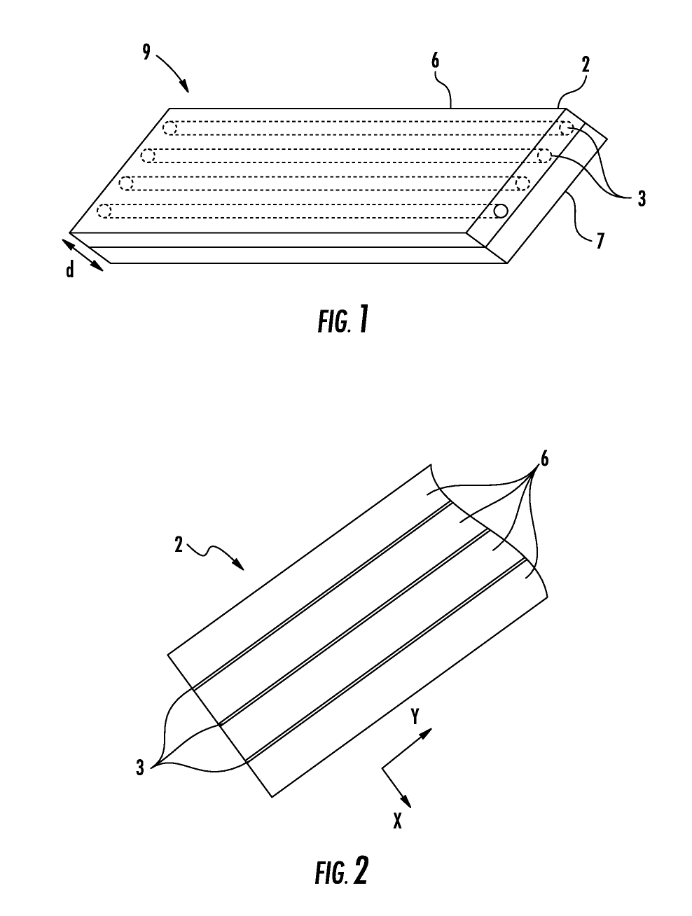

FIG. 1 schematically illustrates one embodiment of a multilayer composite 9. The multilayer composite includes a continuous fiber composite layer 2 and an adjacent layer 7 that is formed directly on the continuous fiber composite from the melt. Both the continuous fiber composite layer 2 and the adjacent layer 7 are formed of polymer compositions that each include a polyarylene sulfide. Specifically, the continuous fiber composite layer 2 includes a plurality of continuous fibers 3 embedded in a polymer composition 6 and the adjacent molded layer 7 is formed of a second polymer composition that can be the same or different as the first polymer composition 6 of the continuous fiber composite layer 2. By inclusion of polyarylene sulfide in both layers 2, 7, the multilayer composite 9 can exhibit the desirable qualities of polyarylene sulfides throughout the product including high chemical, thermal, and mechanical resistance. In addition, the multilayer composite 9 can exhibit high strength due to the continuous fibers of the layer 2.

Though illustrated in FIG. 1 with a single continuous fiber composite layer 2 and a single adjacent layer 7, it should be understood that the multilayer composites can include additional layers. For instance, a multilayer composite can include multiple layers of continuous fiber composites with the orientation of the fibers of different layers at an angle to one another, which can further improve the strength characteristics of the multilayer composites.

Due to the utilization of polyarylene sulfide polymers in both the continuous fiber composite layer 2 and the adjacent layer 7, as well due to the formation methods employed, the layers 2, 7 of the multilayer composite 9 can strongly adhere to one another with little or no demarcation between the adjacent layers. As such, the problems associated with delamination between adjacent layers of continuous fiber composites as have been known in the past can be essentially eliminated.

In addition, the strength characteristics of the multilayer composite can match or exceed those of composites formed in the past from multiple continuous fiber tapes layered with one another. Accordingly, products can be formed that meet strength specifications using less continuous fiber composite material as compared to previously utilized multilayer composites, which can provide costs savings.

As stated, the multilayer composites can exhibit excellent strength characteristics. For instance, the multilayer composites can exhibit a maximum load of greater than about 68 pounds force (lb-f) (about 302 Newtons), greater than about 95 lb-f (about 423 N), greater than about 115 ft-lb (about 511 N), greater than about 150 ft-lb (about 707 N), or greater than about 190 ft-lb (about 845 N), as determined by a multiaxial impact test according to ASTM D3763 (equivalent to ISO Test Method No. 6603) at 23° C. and 11 ft/sec (3.4 m/sec). The multilayer composites can exhibit a total energy as determined by a multiaxial impact test of greater than about 2.6 ft lb-f (about 3.2 Joules), greater than about 3 ft lb-f (about 4 J), greater than about 3.5 ft lb-f (about 4.7 J), greater than about 4 ft lb-f (about 5.4 J), or greater than about 4.5 ft lb-f (about 6.1 J).

The multilayer composites can also exhibit excellent flexural properties. For instance, the multilayer composites can exhibit a flexural modulus of greater than about 14,400 megapascals (MPa), greater than about 15,000 MPa, greater than about 20,000 MPa, or greater than about 22,000 MPa. The multilayer composites can exhibit a flexural strength of greater than about 250 MPa, greater than about 500 MPa, or greater than about 600 MPa; and the multilayer composites can exhibit a flexural strain of greater than about 2 MPa, greater than about 2.5 MPa, or greater than about 3 MPa. Flexural properties can be determined according to ISO Test No. 178 (technically equivalent to ASTM D790) at 23° C.

The polyarylene sulfide(s) of the compositions used to form the different layers of a multilayer composite may be a polyarylene thioether containing repeat units of the formula (I);

—[(Ar¹)ₙ—X]ₘ—[(Ar²)ᵢ—Y]ⱼ—[(Ar³)ₖ—Z]ₗ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes more than about 30 mol %, more than about 50 mol %, or more than about 70 mol % arylene sulfide (—S—) units. In one embodiment the polyarylene sulfide includes at least 85 mol % sulfide linkages attached directly to two aromatic rings.

In one embodiment, the starting polyarylene sulfide is a polyphenylene sulfide, defined herein as containing the phenylene sulfide structure —(C₆H₄—S)ₙ— (wherein n is an integer of 1 or more) as a component thereof.

The polyarylene sulfide may be synthesized prior to formation of the various layers of the multilayer composite. Formation of the polyarylene sulfide is not a requirement, however, and the polyarylene sulfide of each layer can also be purchased from known suppliers. For instance Fortron® polyphenylene sulfide available from Ticona of Florence, Ky., USA can be purchased and utilized to form the multilayer composite.

Synthesis techniques that may be used in making a polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a polyarylene sulfide copolymer can be formed containing segments having the structure of formula (II):

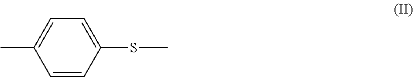

and segments having the structure of formula (III):

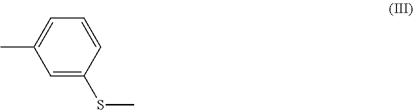

or segments having the structure of formula (IV):

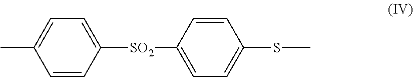

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

A process for producing the polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polyarylene sulfide may be linear, semi-linear, branched or crosslinked. A linear polyarylene sulfide includes as the main constituting unit the repeating unit of —(Ar—S) —. In general, a linear polyarylene sulfide may include about 80 mol % or more of this repeating unit. A linear polyarylene sulfide may include a small amount of a branching unit or a cross-linking unit, with the amount of branching or cross-linking units generally less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the polyarylene sulfide may be washed with liquid media. For instance, the polyarylene sulfide may be washed with water, acetone, N-methyl-2-pyrrolidone, a salt solution, and/or an acidic media such as acetic acid or hydrochloric acid. The polyarylene sulfide can be washed in a sequential manner that is generally known to persons skilled in the art. Washing with an acidic solution or a salt solution may reduce the sodium, lithium or calcium metal ion end group concentration from about 2000 ppm to about 100 ppm.

Organic solvents that will not decompose the polyarylene sulfide can be used for washing. Organic solvents can include, without limitation, nitrogen-containing polar solvents such as N-methylpyrrolidone, dimethylformamide, dimethylacetamide, 1,3-dimethylimidazolidinone, hexamethylphosphoramide, and piperazinone; sulfoxide and sulfone solvents such as dimethyl sulfoxide, dimethylsulfone, and sulfolane; ketone solvents such as acetone, methyl ethyl ketone, diethyl ketone, and acetophenone, ether solvents such as diethyl ether, dipropyl ether, dioxane, and tetrahydrofuran; halogen-containing hydrocarbon solvents such as chloroform, methylene chloride, ethylene dichloride, trichloroethylene, perchloroethylene, monochloroethane, dichloroethane, tetrachloroethane, perchloroethane, and chlorobenzene; alcohol and phenol solvents such as methanol, ethanol, propanol, butanol, pentanol, ethylene glycol, propylene glycol, phenol, cresol, polyethylene glycol, and polypropylene glycol; and aromatic hydrocarbon solvents such as benzene, toluene, and xylene. Further, solvents can be used alone or as a mixture of two or more thereof.

A composition used to form a layer of a multilayer composite may generally include a polyarylene sulfide (or a blend of multiple polyarylene sulfides) in an amount from about 1% to about 90%, from about 2% to about 60% by weight of the composition, or from about 5% to about 40% by weight of the composition.

According to one embodiment, the polyarylene sulfide of one or more layers of the multilayer composite can be reacted with a disulfide compound prior to formation of the multilayer composite. Reaction with a disulfide compound can cause scission of the polyarylene sulfide that can lower the melt viscosity of the polymer and improve processing conditions of the composition. For instance, the polyarylene sulfide can have a melt viscosity of less than about 1500 poise, less than about 1000 poise, less than about 500 poise, or less than about 400 poise as determined in accordance with ISO Test No. 11443 at a shear rate of 1200 s⁻¹ and at a temperature of 310° C.

Reaction with a disulfide compound can also allow for formation of a low halogen content product. For example, a high molecular weight, low chlorine content polyarylene sulfide can be reacted with a disulfide compound to cause chain scission of the polymer, and the resulting polyarylene sulfide reaction product can exhibit a relatively low melt viscosity and can also retain the low chlorine content of the original starting polyarylene sulfide. For instance, the polyarylene sulfide composition can have a chlorine content of less than about 1000 parts per million (ppm), less than about 900 ppm, less than about 600 ppm, or less than about 400 ppm. The low melt viscosity, low chlorine content polyarylene sulfide can then be used to form one or more layers of the multilayer composite.

The disulfide compound may have the structure of formula (V):

R³—S—S—R⁴ (V)

wherein R³ and R⁴ may be the same or different and are hydrocarbon groups that independently include from 1 to about 20 carbons. For instance, R³ and R⁴ may independently be an alkyl, cycloalkyl, aryl, or heterocyclic group.

According to one embodiment, the polyarylene sulfide can be reacted with a disulfide compound that includes reactive functionality. For example, the disulfide compound of formula (V) can include reactive functionality at the terminal ends of one or both of R³ and R⁴, and this reactively functionalized disulfide compound can be reacted with a polyarylene sulfide to form a reactively functionalized polyarylene sulfide for use in forming one or more layers of a multilayer composite.

By way of example, at least one of R³ and R⁴ may include a terminal carboxyl group, hydroxyl group, an amino group (either substituted or nonsubstituted), a nitro group, or the like. Examples of disulfide compounds including reactive terminal groups as may be combined with a polyarylene sulfide may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid, dithioglycolic acid, α,α′-dithiodilactic acid, β,β′-dithiodilactic acid, 3,3′-dithiodipyridine, 4,4′ dithiomorpholine, 2,2′-dithiobis(benzothiazole), 2,2′-dithiobis(benzimidazole), 2,2′-dithiobis(benzoxazole), L-Cysteine, dithiobenzoic acid, dihydroxyphenyl disulfide, and 2-(4′-morpholinodithio)benzothiazole.

The amount of the disulfide compound combined with a polyarylene sulfide can generally be from about 0.1% to about 3% by weight of the polyarylene sulfide composition used to form a layer of the multilayer composite, for instance from about 0.1% to about 1% by weight of the polyarylene sulfide composition.

While not wishing to be bound to any particular theory, it is believed that utilization of a reactively functionalized polyarylene sulfide in one or more of the layers of the multilayer composite can improve bonding between components of an individual layer of the composite as well as between layers of the composite. For example, upon embedding of continuous fibers into a polymeric composition including the reactively functionalized polyarylene sulfide, the reactivity of the polyarylene sulfide can enhance adhesion between the polyarylene sulfide polymer and the fibers. Without being bound by any particular theory, it is believed that the enhanced adhesion is due to improved bonding between the polyarylene sulfide and the surface of the fiber, e.g., bonding between functional groups present in the sizing on the surface of a carbon fiber and the reactive functionality of the polyarylene sulfide. The reactivity of the polyarylene sulfide can also improve bonding between the layers of the multilayer composite. Thus, addition of the reactively functionalized polyarylene sulfide is not limited to the polyarylene sulfide of the continuous fiber composite layer, but may be included in other layers of the multilayer composite as well, and specifically, may be included in the polyarylene sulfide layer that is directly formed from the melt on the continuous fiber composite layer.

In general, the continuous fiber composite layer of a multilayer composite can be formed and shaped prior to combination with the polymer melt that forms the adjacent layer of the multilayer composite. One embodiment of a continuous fiber composite is illustrated in FIG. 2. As can be seen, the continuous fiber composite 2 includes a plurality of unidirectionally aligned fibers 3 embedded within the polymer composition 6. The continuous fiber composite layer can generally include a loading level of continuous fibers of greater than about 10%, greater than about 20%, or greater than about 30% by weight of the continuous fiber composite. According to one embodiment, the continuous fiber composite can include a high loading level of continuous fibers in the composite, for instance greater than about 40%. For instance, in those embodiments in which the polyarylene sulfide is reactively functionalized through reaction with a disulfide compound, the continuous fiber composite can include a high loading level of continuous fibers due to the improved bonding between the polyarylene sulfide and the fibers such as greater than about 40%, greater than about 50% or greater than about 60% by weight of the continuous fiber composite.

The fibers incorporated into the continuous fiber composite can be any continuous fiber as is known in the art including, without limitation, 1) inorganic crystals or polymers, such as fibrous glass, quartz fibers, silica fibers and fibrous ceramics, which include alumina-silica (refractory ceramic fiber), boron fibers, silicon carbide fibers or monofilament metal oxide fibers, including alumina-boria-silica, alumina-chromia-silica, zirconia-silica, and the like; 2) organic polymer fibers, such as fibrous carbon, fibrous graphite, acetates, acrylics (including acrylonitriles), aliphatic polyamides (e.g., nylons), aromatic polyamides, polyesters, flax, polyethylenes, polyurethanes (e.g., spandex), alpha-cellulose, cellulose, regenerated cellulose (e.g., rayon), jutes, sisals, vinyl chlorides, e.g., vinyon, vinyldienes (e.g., saran) and thermoplastic fibers; 3) metal fibers, such as aluminum, boron, bronze, chromium, nickel, stainless steel, titanium and their alloys; and 4) “Whiskers” which are single, inorganic crystals.

As inorganic continuous fibers, there may be listed, for instance, fibers formed from glass such as hard glass fibers; fibers formed from quartz such as molten quartz fibers; fibers derived from naturally-occurring minerals such as rock wool; fibers formed from metals; and fibers formed from carbon. The inorganic fibers may be used alone or in combination. It is also possible to use fibers obtained by forming any combination of the foregoing inorganic materials into fibers.

As organic continuous fibers, there may be listed, for instance, fibers formed from polyamide resins, in particular, those prepared from complete aromatic fibers such as aramid, e.g., Kevlar®; and fibers formed from polyester resins, in particular, those formed from complete aromatic fibers and polyimide resins. The organic fibers may be used alone or in combination. Moreover, it is also possible to use fibers formed from a polyarylene sulfide resin composition for forming a continuous fiber as may be incorporated in the composite.

A combination of organic and inorganic fibers may also be incorporated in the continuous fiber composite.

When utilizing an organic continuous fiber, the organic fiber material should be selected in such a manner that the resin from which the continuous fiber is formed has a melting point (or thermal decomposition temperature) higher than that of the polymer composition including a polyarylene sulfide that is to be combined with the continuous fiber in order to prevent any damage to the shape of the continuous fibers present in the continuous fiber composite.

According to one embodiment, the continuous fiber can be a continuous carbon fiber. By way of example and without limitation, carbon fibers including amorphous carbon fibers, graphitic carbon fibers, metal-coated carbon fibers, or mixtures thereof can be incorporated in a continuous fiber composite layer.

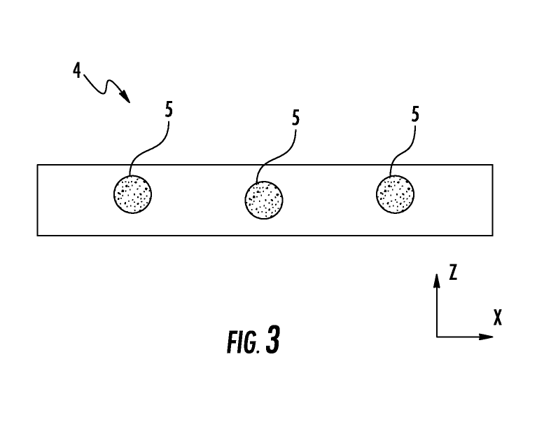

The fibers can be in the form of individual fibers or in the form of fiber rovings. As used herein, the term “roving” generally refers to a bundle or tow of individual fibers. The fibers contained within the roving can be twisted or can be straight. The number of fibers contained in each roving can be constant or vary from roving to roving. Typically, a roving contains from about 1,000 fibers to about 100,000 individual fibers, and in some embodiments, from about 5,000 to about 50,000 fibers. For example, FIG. 3 illustrates a cross sectional view of a composite tape 4 that includes a plurality of continuous carbon fiber rovings 5.

The continuous fibers employed can possess a high degree of tensile strength relative to their mass. For example, the ultimate tensile strength of continuous carbon fibers is typically from about 1,000 to about 10,000 Megapascals (“MPa”), in some embodiments from about 2,000 MPa to about 8,000 MPa, and in some embodiments, from about 3,000 MPa to about 7,000 MPa. Such tensile strengths may be achieved even though the fibers are of a relatively light weight, such as a mass per unit length of from about 0.1 to about 2 grams per meter, in some embodiments from about 0.4 to about 1.5 grams per meter. The ratio of tensile strength to mass per unit length may thus be about 1,000 MPa per gram per meter (“MPa/g/m”) or greater, in some embodiments about 4,000 MPa/g/m or greater. For instance, the continuous fibers can have a tensile strength to mass ratio in the range of from about 5,000 to about 7,000 MPa/g/m. The continuous fibers often have a nominal diameter of about 4 to about 35 micrometers, and in some embodiments, from about 5 to about 35 micrometers.

A melt processing device is generally employed to form the continuous fiber composite. In one embodiment, a single device can be used to form the polymer composition and to embed the continuous fibers within the polymer composition, although this is not a requirement, and a polymer composition including a polyarylene sulfide can first be formed, for instance in an extrusion device as is generally known. Following initial formation, the polymer composition, for instance in the form of chips or flakes, can be fed to a device that then embeds the continuous fibers within the polymer composition. Among other things, the melt processing device facilitates the ability of the polymer composition to be applied to the entire surface of the fibers and/or rovings formed of the fibers.

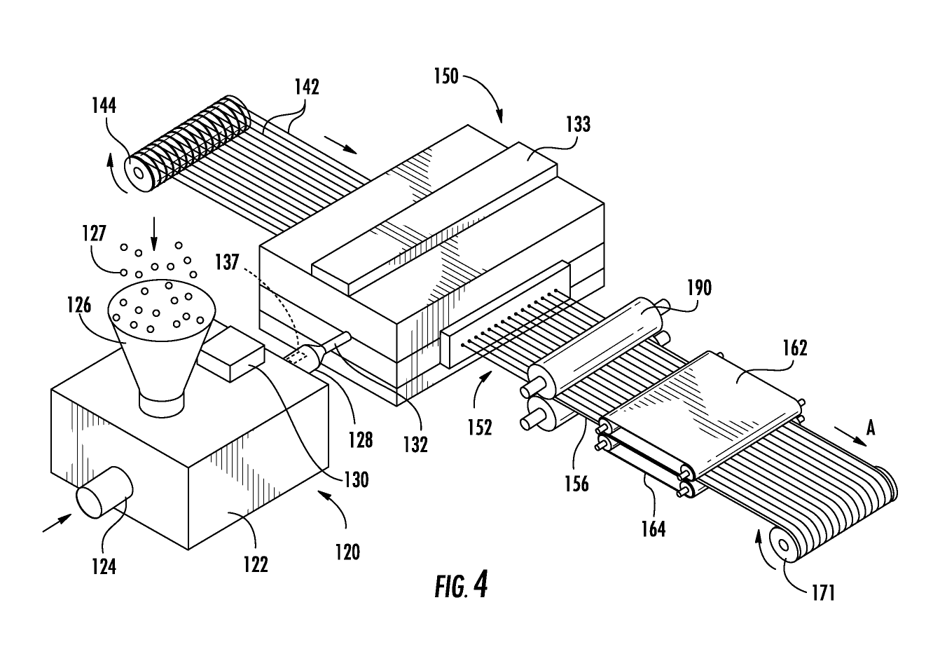

Referring to FIG. 4, one embodiment of such melt processing device is shown. The apparatus includes an extruder 120 containing a screw shaft 124 mounted inside a barrel 122. A heater 130 (e.g., electrical resistance heater) is mounted outside the barrel 122. During use, a feedstock 127 including the polyarylene sulfide (or a polymer composition containing the polyarylene sulfide) and optionally also containing a disulfide compound is supplied to the extruder 120 through a hopper 126.

The feedstock 127 is conveyed inside the barrel 122 by the screw shaft 124 and heated by frictional forces inside the barrel 122 and by the heater 130. The feedstock is heated to a temperature greater than the melting temperature of the polyarylene sulfide, for instance greater than about 280° C., or greater than about 300° C. The polymer composition exits the barrel 122 through a barrel flange 128 and enters a die flange 132 of an impregnation die 150.

Additional components can also be included in the feedstock. For example, a feedstock that is either pre-formed prior to addition at the hopper 126 or formed within the barrel 122 via addition of components at the hopper 126 can include the polyarylene sulfide (with or without reactive functionalization) in combination with one or more additives as are generally known in the art including, without limitation, impact modifiers, fillers, antimicrobials, lubricants, pigments or other colorants, antioxidants, stabilizers, surfactants, flow promoters, solid solvents, and other materials added to enhance properties and processibility. Such optional materials may be employed in the polymer composition in conventional amounts and according to conventional processing techniques.

Additional components that may be included in a polymer composition can include additional polymers that may be blended with the polyarylene sulfide. By way of example the polyarylene sulfide can be blended with a liquid crystal polymer to form a polymer composition. For example, a polymer composition can include up to about 40% by weight of a liquid crystal polymer blended with the polyarylene sulfide and any other additives.

A plurality of continuous fibers 142 or a plurality of continuous fiber rovings 142 is supplied from a reel or reels 144 to die 150. The rovings 142 (or continuous fibers 142 in those embodiments in which the fibers are not gathered together into the form of rovings) are generally kept apart a certain distance before combination with the polymer melt, such as at least about 4 millimeters, and in some embodiments, at least about 5 millimeters. The polymer composition may further be heated inside the die by heaters 133 mounted in or around the die 150. The die is generally operated at temperatures that are sufficient to cause melting, impregnation, and adhesion of the polymer composition with the continuous fibers. Typically, the operation temperatures of the die is higher than the melt temperature of the polymer composition, such as at temperatures from about 300° C. to about 450° C. When processed in this manner, the continuous fiber rovings 142 become embedded in the polymer composition. The extrudate 152 is then extruded from the impregnation die 150.

A pressure sensor senses the pressure near the impregnation die 150 to allow control to be exerted over the rate of extrusion by controlling the rotational speed of the screw shaft 124, or the feed rate of the feeder. That is, the pressure sensor is positioned near the impregnation die 150 so that the extruder 120 can be operated to deliver a correct amount of polymer composition for interaction with the fiber rovings 142.

Within the impregnation die 150, the rovings are traversed through an impregnation zone to impregnate the rovings with the polymer composition. In the impregnation zone, the polymer composition may be forced generally transversely through the rovings by shear and pressure created in the impregnation zone, which significantly enhances the degree of impregnation. This is particularly useful when forming the continuous fiber composite of a high fiber content, such as about 40% by weight of the composite or more. Typically, the die will include a plurality of contact surfaces, for instance having a curvilinear surface, to create a sufficient degree of penetration and pressure on the rovings.

To further facilitate impregnation of the rovings 142, they may also be kept under tension while present within the impregnation die. The tension may, for example, range from about 5 Newtons (N) to about 300 N, in some embodiments from about 50 N to about 250 N, and in some embodiments, from about 100 N to about 200 N per roving 142 or tow of fibers.

Referring again to FIG. 4, the continuous fiber composite extrudate 152 may be further shaped following extrusion. For instance, the continuous fiber composite extrudate 152 may be consolidated as with rollers 190 as illustrated in FIG. 4 to form a composite tape. After leaving the impregnation die 150, the extrudate 152 may enter an optional pre-shaping, or guiding section (not shown) before entering a nip formed between two adjacent rollers 190. Although optional, the rollers 190 can help to consolidate the extrudate 152 into the desired form as well as enhance fiber impregnation and squeeze out any excess voids. In addition to the rollers 190, other shaping devices may also be employed, such as a die system.

In the illustrated embodiment, the resulting consolidated composite tape 156 is pulled by tracks 162 and 164 mounted on rollers. The tracks 162 and 164 also pull the extrudate 152 from the impregnation die 150 and through the rollers 190. If desired, the composite tape 156 may be wound up at a section 171. Generally speaking, the composite tape is relatively thin and typically has a thickness of from about 0.05 to about 1 millimeter, in some embodiments from about 0.1 to about 0.8 millimeters, and in some embodiments, from about 0.2 to about 0.4 millimeters.

Formation of the continuous fiber composite is not limited to the melt extrusion pultrusion method of FIG. 4, and the continuous fiber composite can be produced by a number of impregnation methods including, without limitation, emulsion, slurry, fiber commingling, film interleaving, and dry powder techniques.

An emulsion process can be used to form the composite by forming an aqueous emulsion including the polymer composition having a very small particle size and applying the emulsion to the continuous fibers. For example, the polymer composition can be milled and combined with a diluent such as water or a water-methanol mixture. A suitable methanol to water mixing ratio can be from 30/70 to 50/50 by weight. The continuous fibers can then be soaked in the emulsion and squeezed by means of squeeze rollers, etc. to encourage pickup of the polymer composition by the fibers. The composite can then be dried, usually in a hot air drier.

Slurry coating or wet powder processing can be utilized to form the continuous fiber composite. In slurry coating, a powder including the polymer composition can be suspended in a liquid medium, generally water, wherein no solvency exists between the resin and the medium, and the fiber bundles are drawn through the slurry. The slurry particulate matrix may not wet out the fiber, in which case high pressure can be utilized to consolidate the polymer composition and the fibers into a composite.

To achieve intimate mixing in emulsion or slurry coating, the particle size of the slurry or emulsion can generally be smaller than the fiber diameter.

In fiber commingling, the polymer composition is introduced in fibrous form. Specifically, fibers of the polymer composition and the continuous fibers are mingled as dry blends and wetting of the continuous fibers by a process such as melting the polymer composition fibers is carried out to consolidate the composite. High pressure can also be used during consolidation of the continuous fiber composite.

Film casting is another method that can be utilized in forming the continuous fiber composite layer. A film casting method can include first forming a film of the polymer composition. For example, following initial formation, the polymer composition can be melt extruded to form a film. The continuous fibers can then be sandwiched between two films formed of the polymer composition. The multi-layer structure can then be heated and calendared to force the resin into the fibers and form the continuous fiber composite.

Dry powder coating of continuous fibers is a relatively recent method developed in continuous fiber composite technology. This method may be advantageous in certain embodiments as no solvent is required and no high stress is introduced in the process. The ultimate goal for almost all powder coating applications is the ability to deposit a thin, even thickness, high quality coating as efficiently as possible. The polymer composition can be solid at ambient and elevated storage temperatures, and can be capable of melting to form an adequately low viscosity material that can permit flow and to penetrate the fiber tow when heated.

In a dry powder process, substantial wet-out of the fibers by the polymer composition can be accomplished such that the polymer composition is liquefied sufficiently to achieve adhesion to the continuous fibers, generally without the use of a conventional adhesive or binder. Wet-out can be accomplished via a polymer composition liquifier, such as a melter or oven, which, through heat, puts the polymer composition into a liquid state. There are various liquifiers available, including any of the radiation or conduction ovens. Additionally, a hot die can be used in place of an oven.

As the polymer composition is liquefied during the process, it is possible to use any size particles of the powder to coat the continuous fibers, including coarse particles. The liquefaction of the polymer composition and the wicking of the material along the fibers can reduce the problem of coarse blending between matrix material and the fibers that is often associated with applying large diameter particles to small diameter fibers. In general, the particle size can range from the diameter or thickness of the fibers or smaller, which is the generally accepted size in the art for coating, to a diameter or thickness many times larger than that of the fibers. The use of large diameter or thickness particles of the polymer composition can also result in significant cost savings.

To achieve substantial wet-out of the continuous fibers, sufficient residence time in the apparatus selected to put the polymer composition in a liquid state and to allow the material to sufficiently wet-out the fibers is required. Moreover, during the wet-out stage the fibers should not be allowed to collapse laterally. This is prevented by maintaining sufficient tension on the fibers.

Regardless of the technique employed, the continuous carbon fibers are oriented in the longitudinal direction (the machine direction “A” of the system of FIG. 4) to enhance tensile strength. Besides fiber orientation, other aspects of the process are also controlled to achieve the desired strength.

The impregnated rovings can also have a very low void fraction, which helps enhance strength. For instance, the void fraction may be about 3% or less, in some embodiments about 2% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-08 to determine the weights of the fibers and the polyarylene sulfide matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a liquid or gas pycnometer (e.g., helium pycnometer);

ρₜ is the theoretical density of the composite as is determined by the following equation:

ρₜ=1/[W_{f}/ρ_{f}+Wₘ/ρₘ]

ρₘ is the density of the polyarylene sulfide (e.g., at the appropriate crystallinity);

ρ_{f} is the density of the fibers;

W_{f} is the weight fraction of the fibers; and

Wₘ is the weight fraction of the polyarylene sulfide.

Alternatively, the void fraction may be determined by chemically dissolving the polyarylene sulfide in accordance with ASTM Standard Test Method No. D 3171-09. In other cases the void fraction may be indirectly calculated based on the densities of the polyarylene sulfide, the fibers, and the continuous composite fiber in accordance with ASTM Standard Test Method No. D 2734-09 (Method A), where the densities may be determined ASTM Standard Test Method No. D792-08 Method A. Of course, the void fraction can also be estimated using conventional microscopy equipment.

Following initial formation of the continuous fiber composite layer, the layer can be shaped prior to molding of the second layer of the multilayer composite over the continuous fiber composite layer. Conventional shaping processes can be used for forming the initial layer out of the continuous fiber composite extrudate 152 including, without limitation, thermoforming, compression molding, hot-stamping and so forth. For instance the continuous fiber composite can be thermoformed or hot stamped to a desired shape and a second polymer composition that includes a polyarylene sulfide can then applied in the melt onto the shaped continuous fiber composite.

A second polymer composition can be molded over the continuous fiber composite to form a multilayer composite. The polymer composition used in forming the layer adjacent to the continuous fiber composite layer can be the same or different as the polymer composition utilized in formation of the continuous fiber composite. For instance, one or both layers can include a polyarylene sulfide formed according to a process that includes reaction of a polyarylene sulfide with a non-functional or a reactively functionalized disulfide compound. Other additives as are generally known in the art may be incorporated in the polymer compositions including, without limitation, impact modifiers, fillers, antimicrobials, lubricants, pigments or other colorants, antioxidants, stabilizers, surfactants, flow promoters, solid solvents, and other materials added to enhance properties and processibility.

Any suitable molding equipment may generally be employed in forming the second layer on the first layer. Referring to FIG. 5, for example, one embodiment of an injection molding apparatus or tool 10 that may be employed is shown. In this embodiment, the apparatus 10 includes a first mold base 12 and a second mold base 14, which together define an article or component-defining mold cavity 16. The molding apparatus 10 also includes a resin flow path that extends from an outer exterior surface 20 of the first mold half 12 through a sprue 22 to a mold cavity 16. The resin flow path may also include a runner and a gate, both of which are not shown for purposes of simplicity.

The continuous fiber composite may be located within the mold cavity 16, for instance at a portion of or over the entire surface of the mold cavity 16, leaving the resin flow path open for access to the mold cavity. An adhesive may be utilized to maintain the continuous fiber composite at the desired location during the molding process, though this is not a requirement of the formation process. The polymer composition may be supplied to the resin flow path using a variety of techniques. For example, the polymer composition may be supplied (e.g., in the form of pellets) to a feed hopper attached to an extruder barrel that contains a rotating screw (not shown). As the screw rotates, the pellets are moved forward and undergo pressure and friction, which generates heat to melt the pellets. Additional heat may also be supplied to the composition by a heating medium that is communication with the extruder barrel. One or more ejector pins 24 may also be employed that are slidably secured within the second mold half 14 to define the mold cavity 16 in the closed position of the apparatus 10. The ejector pins 24 operate in a well-known fashion to remove a molded part from the cavity 16 in the open position of the molding apparatus 10.

As is known in the art, injection can occur in two main phases—i.e., an injection phase and holding phase. During the injection phase, the mold cavity is completely filled with the molten polymer composition. The holding phase is initiated after completion of the injection phase in which the holding pressure is controlled to pack additional material into the cavity and compensate for volumetric shrinkage that occurs during cooling. Over the course of the injection phase and the holding phase, the polymer composition can adhere to the continuous fiber composite layer held at the surface of the mold cavity. After the shot has built, it can then be cooled. Once cooling is complete, the molding cycle is completed when the mold opens and the composite part is ejected, such as with the assistance of ejector pins within the mold. The composite part will include the continuous fiber composite layer strongly adhered to the second polymer composition molded according to the injection molding process.

A cooling mechanism may also be provided to solidify the composition within the mold cavity. In FIG. 5, for instance, the mold bases 12 and 14 each include one or more cooling lines 18 through which a cooling medium flows to impart the desired mold temperature to the surface of the mold bases for solidifying the molten material. The total cooling time can be determined from the point when the composition is injected into the mold cavity to the point that it reaches an ejection temperature at which it can be safely ejected. Exemplary cooling times may range, for instance, from about 1 to about 60 seconds, in some embodiments from about 5 to about 40 seconds, and in some embodiments, from about 10 to about 35 seconds.

As a result of the combination of component layers employed in the present invention, it has been discovered that the multilayer composite can be readily formed into parts having a small dimensional tolerance. For example, the multilayer composite may be molded into a part for use in an electronic device. The part may be in the form of a planar substrate having a thickness of about 10 millimeters or less, in some embodiments about 5 millimeters or less, in some embodiments from about 100 micrometers to about 2 millimeters, and in some embodiments, from about 200 micrometers to about 1 millimeter. Alternatively, the part may simply possess certain features (e.g., walls, ridges, etc.) within the thickness ranges noted above. Examples of electronic devices that may employ such a molded part include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), etc.

Wireless electronic devices, however, are particularly suitable. Examples of suitable wireless electronic devices may include a desktop computer or other computer equipment, a portable electronic device, such as a laptop computer or small portable computer of the type that is sometimes referred to as “ultraportables.” In one suitable arrangement, the portable electronic device may be a handheld electronic device. Examples of portable and handheld electronic devices may include cellular telephones, media players with wireless communications capabilities, handheld computers (also sometimes called personal digital assistants), remote controls, global positioning system (“GPS”) devices, and handheld gaming devices. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

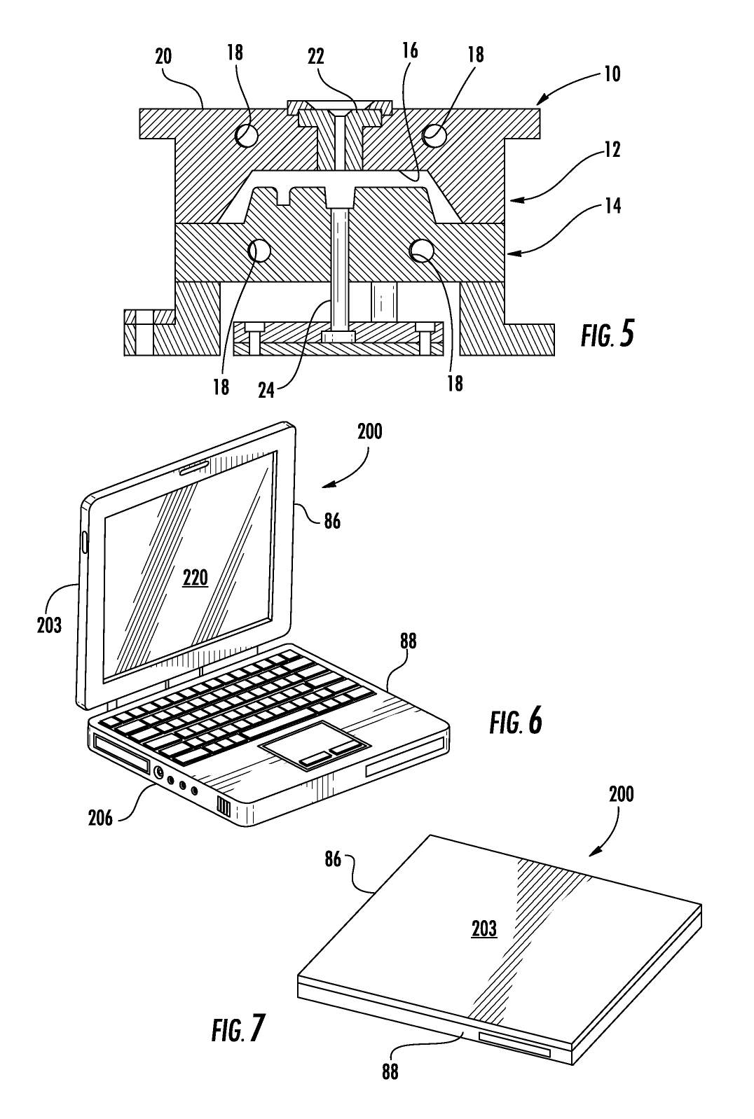

Referring to FIGS. 6-7, one particular embodiment of an electronic device 200 is shown as a portable computer. The electronic device 200 includes a display member 203, such as a liquid crystal diode (LCD) display, an organic light emitting diode (OLED) display, a plasma display, or any other suitable display. In the illustrated embodiment, the device is in the form of a laptop computer and so the display member 203 is rotatably coupled to a base member 206. It should be understood, however, that the base member 206 is optional and can be removed in other embodiments, such as when device is in the form of a tablet portable computer. Regardless, in the embodiment shown in FIGS. 6-7, the display member 203 and the base member 206 each contain a housing 86 and 88, respectively, for protecting and/or supporting one or more components of the electronic device 200. The housing 86 may, for example, support a display screen 220 and the base member 206 may include cavities and interfaces for various user interface components (e.g., keyboard, mouse, and connections to other peripheral devices). Although the multilayer composite of the present invention may generally be employed to form any portion of the electronic device 200, it is typically employed to form all or a portion of the housing 86 and/or 88. When the device is a tablet portable computer, for example, the housing 88 may be absent and the multilayer composite may be used to form all or a portion of the housing 86. Regardless, due to the unique properties achieved by the multilayer composite, the housing(s) or a feature of the housing(s) may be molded to have a very small wall thickness, such as within the ranges noted above.

Although not expressly shown, the device 200 may also contain circuitry as is known in the art, such as storage, processing circuitry, and input-output components. Wireless transceiver circuitry in circuitry may be used to transmit and receive radio-frequency (RF) signals. Communications paths such as coaxial communications paths and microstrip communications paths may be used to convey radio-frequency signals between transceiver circuitry and antenna structures. A communications path may be used to convey signals between the antenna structure and circuitry. The communications path may be, for example, a coaxial cable that is connected between an RF transceiver (sometimes called a radio) and a multiband antenna.

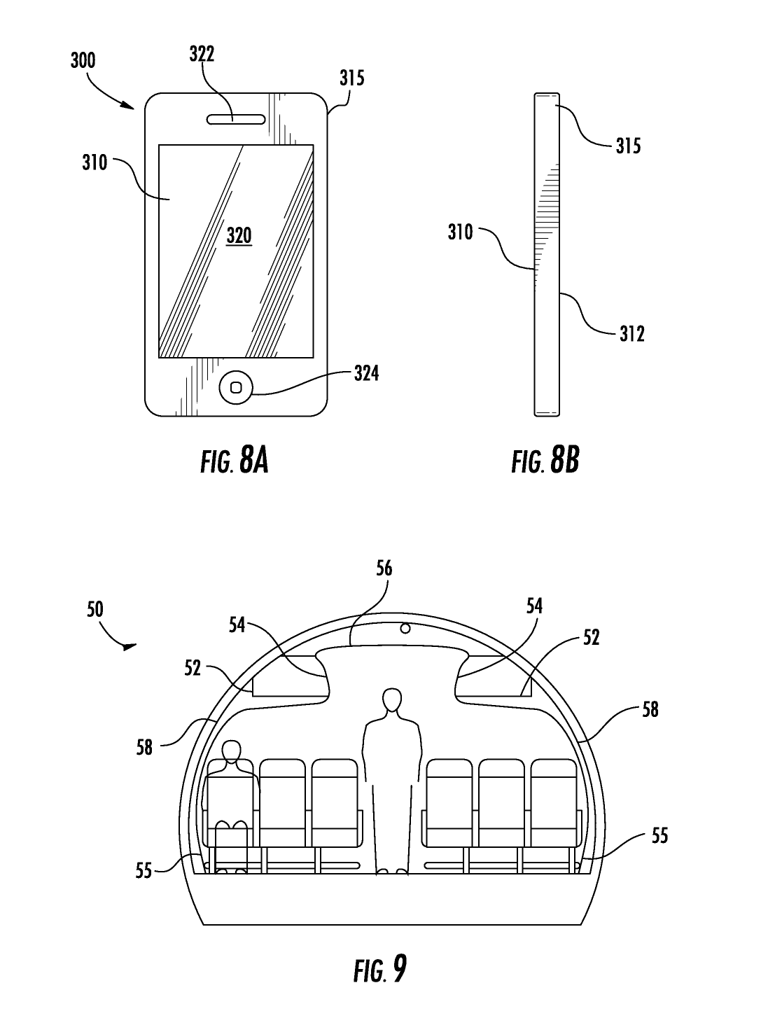

Referring to FIG. 8, another example of an electronic device is illustrated as may incorporate the multilayer composite. FIG. 8 illustrates a smart phone 300 in a front view (FIG. 8A) and a side view (FIG. 8B). The smart phone 300 includes a touch screen 320, a speaker 322, and a control button 324 on the face 310 as shown in FIG. 8A. At least a portion of the housing 315 of the smart phone 300 can be formed of the multilayer composite as described herein. Due at least in part to the small cross sectional dimension of the housing material, for instance less than about 1 millimeter, the cross sectional dimension of the smart phone 300, i.e. the width of the smart phone 300 as measured from the face 310 to the back 312 of the smart phone 300 can be quite small, for instance less than about 15 millimeters, or less than about 10 millimeters.

The multilayer composite material can be utilized in formation of a wide variety of products that require high strength characteristics in addition to defining a small cross sectional dimension, and is not limited to the formation of electronic components. For example, in one embodiment, the multilayer composite materials can be utilized in transportation applications, for instance in formation of panels for use in aeronautical or ground transportation applications. The multilayer composites can be beneficially utilized, for instance in interior door, roof, or side panels in cars, trucks, buses, passenger trains, or airplanes. The multilayer composite can be utilized as other components as well, for instance in forming seats, tray tables or other tables for use in a transportation application.

FIG. 9 illustrates one embodiment in which the multilayer composite material can be utilized in aircraft interior. FIG. 9 schematically illustrates a cross-section through an aircraft fuselage 50 of the single aisle type, though the multilayer composite material may be beneficially utilized in forming aircraft of any size and shape. Panels as may be formed of the multilayer composite material can include, by way of example, and without limitation, the overhead racks or storage bins 52, the over-aisle head panels 54 that widen upwardly to an enlarged ceiling panel area, a ceiling panel 56, side wall panels 58, and lower wall panels 55. The number and size of the individual panels will generally vary from one aircraft to another. For example, a typical cross-section of the type of aircraft having fuselage 50 includes two storage bins, one ceiling panel, two side wall panels, and two lower wall panels. Other components of a vehicle as may be formed of the multilayer composite can include, without limitation, arm rests, seat panels, foot rests, and so forth. Variations of individual components are well known in the art.

The present disclosure may be better understood with reference to the following examples.

### Example 1

### Testing Methods

Flexural properties were determined according to ASTM Test Method No. D790-03. According to the test method, a bar of rectangular cross section rests on two supports and is loaded by means of a loading nose midway between the supports. A supported span-to-depth ration of 16:1 is used. The specimen is deflected until rupture occurs in the outer surface of the test specimen or until a maximum strain of 5.0% is reach, whichever occurs first. Procedure A is employed that utilizes a strain rate of 0.01 mm/mm/min, the support and nose radius was 5 millimeters, the support span was 3.68 inches, and the test speed was 0.1 inches per minute.

Multi-axial impact tests were carried out according to ASTM No. D3763 (equivalent to ISO Test Method No. 6603) at 23° C. and 11 ft/sec (3.4 m/sec). According to the test method, a four inch by four inch plaque of the multilayer composite material is mounted in the grips of the mechanical testing machine. The maximum load of the material can be determined from the maximum force carried before failure.

### Materials

Materials utilized to form the compositions included the following:

Polyarylene Sulfide:

Fortran® 0214 polyphenylene sulfide available from Ticona Engineering Polymers of Florence, Ky. (PPS 0214)

Fortran® 0205 polyphenylene sulfide available from Ticona Engineering Polymers of Florence, Ky. (PPS 0205)

Functionalization agent: 2,2-dithiosalicylic acid (DTSA)

Carbon fiber rovings: Torayca® T700S-50C 12k available from Toray Carbon Fibers America, Inc.)

Lubricant: Glycolube® P available from Lonza Group Ltd.

Fiber Glass: 910a10c fiberglass available from OCV™.

Colorant: FO 1100C2 Black concentrate

Aminosilane: aminopropyl triethoxysilane

### Specimen Formation

Two continuous fiber tapes were formed. Carbon fiber rovings were employed as the continuous fibers in the tapes with each individual tape containing three (3) fiber rovings. Continuous fiber tapes were initially formed using an extrusion system as substantially described above and shown in FIG. 4 as described in the table below—all amounts are provided as weight percentages.

| | Tape 1 | Tape 2 |
|---|---|---|
| PPS 0205 resin | 40% | |
| PPS 0214 resin | | 39.7% |
| DTSA | | 0.3% |
| Carbon fiber | 60% | 60% |
| Total | 100% | 100% |

Two polyarylene sulfide compositions were formed as described in the table below:

| | Composition 1 | Composition 2 |
|---|---|---|
| Lubricant | 0.3% | 0.3% |
| Aminosilane | 0.4% | 0.2% |
| Fiber Glass | 40% | 40% |
| Colorant | 2.5% | 2.5% |
| DTSA | | 0.4% |
| PPS 0205 resin | 56.8% | |
| PPS 0214 resin | | 56.6% |
| Total | 100% | 100% |
| composition | | |

Samples formed included the following:

Comparative Sample 1—a plaque molded from Composition 1

Comparative Sample 2—a plaque molded from Composition 2

Inventive Sample 1—A continuous fiber composite layer formed of composition 1 and tape 1, in which composition 1 was molded directly from the melt onto the preformed tape.

Inventive Sample 2—A continuous fiber composite layer formed of composition 1 and tape 2, in which composition 1 was molded directly from the melt onto the preformed tape.

Inventive Sample 3—A continuous fiber composite layer formed of composition 2 and tape 1, in which composition 1 was molded directly from the melt onto the preformed tape.

Inventive Sample 4—A continuous fiber composite layer formed of composition 2 and tape 2, in which composition 1 was molded directly from the melt onto the preformed tape.

Results of physical testing carried out on the samples are provided in the table, below.

| | Comp. | Comp. | Inventive | Inventive | Inventive | Inventive |
|---|---|---|---|---|---|---|
| | Sample 1 | Sample 2 | Sample 1 | Sample 2 | Sample 3 | Sample 4 |
| Multiaxial | | | | | | |
| Impact Test | | | | | | |
| Max. load | 58.7 | 67.9 | 95.4 | 117.4 | 151.6 | 190.3 |
| (lb-f) | | | | | | |
| Std. dev. | 2.7 | 1.8 | 22.2 | 26.7 | 37.2 | 18 |
| Total Energy | 1.86 | 2.59 | 1.95 | 2.49 | 3.73 | 4.92 |
| (ft lb-f) | | | | | | |
| Std. dev. | 0.12 | 0.18 | 0.73 | 0.83 | 1.45 | 1.21 |
| Flexural | | | | | | |
| Testing | | | | | | |
| Flexural | 13611 | 14312 | 22928 | 22984 | 22238 | 22297 |
| Modulus | | | | | | |
| (MPa) | | | | | | |
| Std. dev. | — | — | 200.4 | 392 | 281 | 37.2 |
| Flexural | 248.76 | 246.52 | 536.17 | 622.09 | 622.43 | 632.94 |
| Strength | | | | | | |
| (MPa) | | | | | | |
| Std. dev. | — | — | 44.8 | 19.73 | 18.16 | 1.4 |
| Flexural | 1.99 | 1.79 | 2.45 | 2.95 | 3.35 | 3.44 |
| Strain (MPa) | | | | | | |
| Std. dev. | — | — | 0.2 | 0.14 | 0.17 | 0.1 |

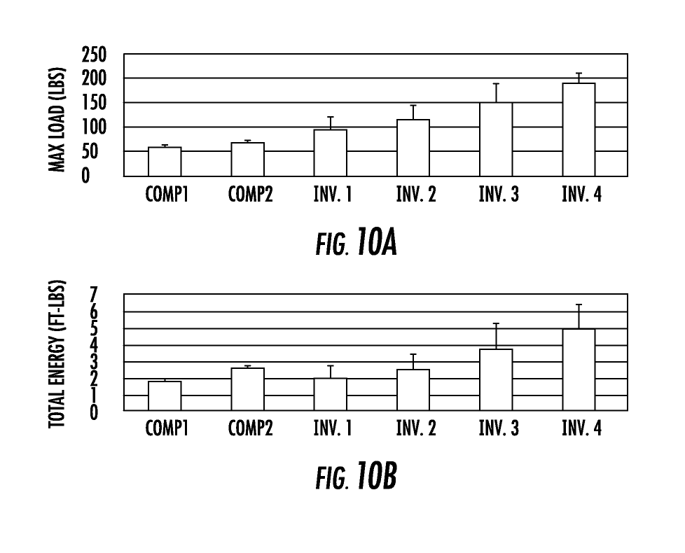

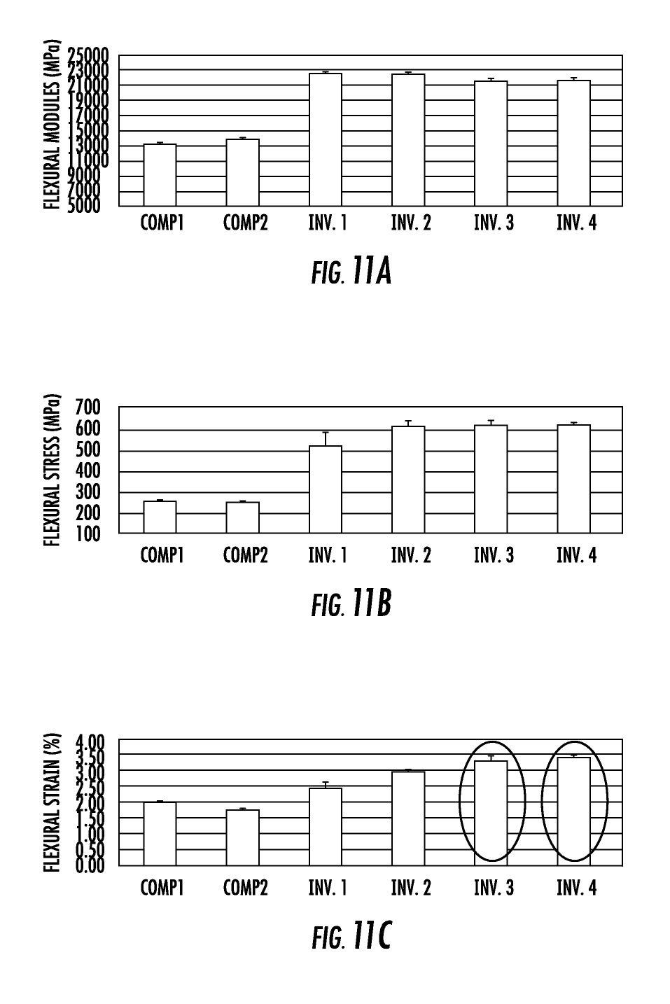

FIGS. 10A and 10B graphically illustrate the differences in the samples with regard to maximum load (FIG. 10A) and total energy (FIG. 10B) in the multiaxial impact test. FIGS. 11A-11C graphically illustrate the flexural differences in the samples including the flexural modulus (FIG. 11A) the flexural stress (FIG. 11B) and the flexural strain (FIG. 11C).

These and other modifications and variations of the present invention may be practiced by those of ordinary skill in the art, without departing from the spirit and scope of the present invention. In addition, it should be understood that aspects of the various embodiments may be interchanged both in whole and in part. Furthermore, those of ordinary skill in the art will appreciate that the foregoing description is by way of example only, and is not intended to limit the invention so further described in such appended claims.

What is claimed is:

1. A multilayer composite having a cross sectional dimension of less than about 10 millimeters, the multilayer composite comprising a continuous fiber composite first layer and a second layer directly molded on the first layer, the first layer including a plurality of oriented continuous fibers embedded in a first polymer composition that includes a first polyarylene sulfide, the second layer comprising a second polymer composition that includes a second polyarylene sulfide.

2. The multilayer composite of claim 1, wherein the first polyarylene sulfide and/or the second polyarylene sulfide is polyphenylene sulfide.

3. The multilayer composite of claim 1, wherein the continuous fibers are continuous carbon fibers.

4. The multilayer composite of claim 1, wherein the continuous fibers are continuous rovings.

5. The multilayer composite of claim 1, wherein the first polyarylene sulfide and/or the second polyarylene sulfide is a reactively functionalized polyarylene sulfide.

6. The multilayer composite of claim 1, wherein the first polyarylene sulfide is the same as the second polyarylene sulfide.

7. The multilayer composite of claim 1, further comprising one or more additional layers.

8. The multilayer composite of claim 1, wherein the multilayer composite has one or more of the following characteristics:
a maximum load of greater than about 68 pounds force (302 Newtons) as determined by a multiaxial impact test according to ASTM D3763 at 23° C. and 3.4 m/sec;
a total energy of greater than about 2.6 foot pounds-force (3.2 Joules) as determined by a multiaxial impact test according to ASTM D3763 at 23° C. and 3.4 m/sec;
a flexural modulus of greater than about 14,400 megapascals as determined according to ASTM D790 at 23° C.;
a flexural strength of greater than about 250 megapascals as determined according to ASTM D790 at 23° C.;
a flexural strain of greater than about 2 megapascals as determined according to ASTM D790 at 23° C.

9. The multilayer composite of claim 1, wherein at least one of the first layer and the second layer has a chlorine content of less than about 1000 parts per million.

10. The multilayer composite of claim 1, wherein the first layer comprises greater than about 40% by weight of the continuous fibers.

11. The multilayer composite of claim 1, wherein at least one of the first polymer composition and the second polymer composition includes an additional polymer in a blend.

12. The multilayer composite of claim 1, wherein the multilayer composite has a cross sectional dimension of less than about 1 millimeter.

13. An electronic device comprising the multilayer composite of claim 1.

14. The electronic device of claim 13, wherein the electronic device is a wireless electronic device.

15. The electronic device of claim 13, wherein the electronic device is a cellular telephone or a computer.

16. A vehicle comprising the multilayer composite of claim 1.

17. The vehicle of claim 16, wherein the multilayer composite forms an interior panel of the vehicle.

18. A method for forming a multilayer composite comprising:
melt processing a first polymer composition that includes a first polyarylene sulfide; and
applying the first polymer composition in the melt onto a continuous fiber composite, the continuous fiber composite containing a plurality of oriented continuous fibers embedded in a second polymer composition that includes a second polyarylene sulfide.

19. The method according to claim 18, wherein the first polymer composition is applied to the continuous fiber composite according to an injection molding process.

20. The method according to claim 18, the method further comprising reacting the first polyarylene sulfide and/or the second polyarylene sulfide with a disulfide compound.

21. The method according to claim 20, wherein the disulfide compound comprises reactive functionality.

22. The method according to claim 18, further comprising embedding the plurality of continuous fibers within the second polymer composition.

23. The method according to claim 18, wherein at least one of the first polymer composition and the second polymer composition has a melt viscosity of less than about 1500 poise as determined in accordance with ISO Test No. 11443 at a shear rate of 1200 s⁻¹ and at a temperature of 310° C.

24. The method according to claim 18, the method further comprising shaping the continuous fiber composite according to a thermoforming, compression molding, or hot-stamping method.
